(19) United States
(12) Patent Application Publication
(10) Pub. No.: US 2021/0150019 A1
(43) Pub. Date: May 20, 2021

(54) USER AUTHENTICATION DEVICE, IMAGE PROCESSING APPARATUS INCLUDING USER AUTHENTICATION DEVICE, AND USER AUTHENTICATION METHOD

(71) Applicant: SHARP KABUSHIKI KAISHA, Sakai City (JP)

(72) Inventor: SHO KAMIHISA, Sakai City (JP)

(21) Appl. No.: 17/087,134

(22) Filed: Nov. 2, 2020

(30) Foreign Application Priority Data
Nov. 19, 2019 (JP) 2019-208823

(51) Int. Cl. G06F 21/45; G06F 21/31

(52) U.S. Cl. CPC G06F 21/45; G06F 21/31

(57) ABSTRACT

A user authentication device includes: a login request receiver that receives a request for a login from a user; an authentication processor that performs user authentication in response to the request; a user information storage that previously stores authentication information used for user authentication; and a communicator that transmits and receives information to and from external image processing apparatuses connected via a network, wherein the authentication processor, in response to the received request, transmits a notification to at least any of the connected external image processing apparatuses via the communicator so as to provide authentication information on the user, and permits a login of the user when the user has been authenticated based on either authentication information stored in the user information storage or authentication information provided by the external image processing apparatus in response to the notification.

### BACKGROUND OF THE INVENTION

### Field of the Invention

The present invention relates to a user authentication device, an image processing apparatus, and a user authentication method, and more particularly, to a user authentication device that performs user authentication to permit the use of a device, an image processing apparatus including the user authentication device, and a user authentication method.

### Description of the Background Art

A device or a system having a plurality of devices connected via a network has the function or setting that needs to be operable exclusively by some people or the data that needs to be accessible exclusively to some people.

In order to determine whether a person is allowed to access (whether the user has authority), a user authentication function is introduced. Typically, a username and a password are previously registered in a device. A user of the device uses his/her username and password to log in the device. Thus, only a registered user may operate the device and access data. Furthermore, a registered user is associated with the user-specific authority so as to limit the operable range and the range of accessible data in accordance with the authority of the user.

Particularly, in the environment where a plurality of devices may transmit and receive information via a network, the number of users who use the devices connected via the network is larger than that of users of a single device. Accordingly, the importance of the user authentication function is increased.

In recent years, a user authentication function has been also introduced for image processing apparatuses. In this description, the image processing apparatus is the collective term for devices that process information regarding an image, such as a scanner, a printer, a facsimile device, a copier, a multifunction peripheral having functions thereof. The user authentication in the image processing apparatus is typically used for the purpose of charging a user and protecting confidential documents and images.

There is the disclosure described below, in the environment where a plurality of image processing apparatuses is connected via a network. One of the image processing apparatuses is configured as a master apparatus, and the other image processing apparatuses are configured as local apparatuses. Each of the master apparatus and the local apparatuses includes a processor that performs an authentication process based on the authentication information stored therein. The master apparatus includes a storage that stores the authentication information on all the users of each image processing apparatus, an editor that edits the authentication information, and a transmitter that transmits the edited authentication information to the local apparatus. The local apparatus includes a receiver that receives authentication information from the master apparatus and an updater that updates the authentication information stored in the local apparatus based on the received authentication information. This configuration enables the centralized management of the authentication information on the users of the image processing apparatuses without using a dedicated authentication server (See, for example, Japanese Unexamined Patent Publication No. 2015-049793).

The configuration disclosed in Japanese Unexamined Patent Publication No. 2015-049793 enables the authentication using the authentication information stored in the local apparatus when the local apparatus is not able to communicate with the master apparatus. The authentication information on the user who logs in the local apparatus for the first time is, however, not registered in the local apparatus. Therefore, the local apparatus is in an unusable status until the communication with the master apparatus is restored.

The present invention has been made in consideration of the above circumstances so as to provide a user authentication device such that, even when the image processing apparatus is not able to communicate with the outside, such as other image processing apparatuses connected via a network, the image processing apparatus may authenticate the user who is authenticated by the other image processing apparatuses, an image processing apparatus including the user authentication device, and a user authentication method.

### SUMMARY OF THE INVENTION

The present invention provides a user authentication device including: a login request receiver that receives a request for a login from a user; an authentication processor that performs user authentication in response to the request; a user information storage that previously stores authentication information used by the authentication processor for user authentication; and a communicator that transmits and receives information to and from external image processing apparatuses connected via a network, wherein the authentication processor, in response to the received request, transmits a notification to at least any of the connected external image processing apparatuses via the communicator so as to provide authentication information on the user, and permits a login of the user when the user has been authenticated based on either authentication information stored in the user information storage or authentication information provided by the external image processing apparatus in response to the notification.

Further, the present invention provides an image processing apparatus including the user authentication device.

Moreover, the present invention according to a different aspect provides a user authentication method implemented by a computer, the user authentication method including: receiving a request for a login from a user; in response to the received request, transmitting a notification to at least any of external image processing apparatuses connected via a network so as to provide authentication information on the user, and permitting a login of the user when the user has been authenticated based on either authentication information previously stored in a user information storage or authentication information provided by the external image processing apparatus in response to the notification.

In the user authentication device according to the present invention, in response to the received request, the authentication processor transmits a notification to at least any of external image processing apparatuses so as to provide authentication information on the user and permits a login of the user when the user has been authenticated based on either authentication information stored in the user information storage or authentication information provided by the external image processing apparatus; thus, it is possible to achieve the user authentication device with which the image processing apparatus may authenticate the user as long as the user information on the user authenticated by the other image processing apparatus has been provided, even if the image processing apparatus is not able to communicate with the outside when a login request is received.

The same holds for the image processing apparatus and the user authentication method described above.

### BRIEF DESCRIPTION OF THE DRAWINGS

FIG. 1 is a block diagram illustrating configurations of a user authentication device and a multifunction peripheral that is an image processing apparatus according to the present embodiment;

FIG. 2 is an explanatory diagram illustrating a configuration in which a plurality of multifunction peripherals storing authentication information is connected via a network according to the present embodiment;

FIG. 3 is an explanatory diagram illustrating how a multifunction peripheral 100A illustrated in FIG. 2 transmits a notification of a user information provision request in response to a login request;

FIG. 4 is an explanatory diagram illustrating how a multifunction peripheral having received the notification of the user information provision request illustrated in FIG. 3 returns stored user information;

FIG. 5 is an explanatory diagram illustrating how the multifunction peripheral 100A illustrated in FIG. 4 further transmits a notification of a user information update request;

FIG. 6A is a flowchart at a first step in which an authentication processor performs user authentication according to the present embodiment (including transmitting a user information provision request in response to a login request and receiving user information);

FIG. 6B is a flowchart at a second step in which the authentication processor performs user authentication according to the present embodiment (including determining the authentication information to be used, performing user authentication, and transmitting a user information update request); and

FIG. 6C is a flowchart at a third step of the user authentication according to the present embodiment (an update process on the receiving side of the user information update request).

### DESCRIPTION OF THE PREFERRED EMBODIMENTS

The present invention is described below in more detail with reference to the drawings. The following description is an example in all aspects and it should not be understood that the description limits the present invention.

### First Embodiment

Configurations of User Authentication Device and Image Processing Apparatus

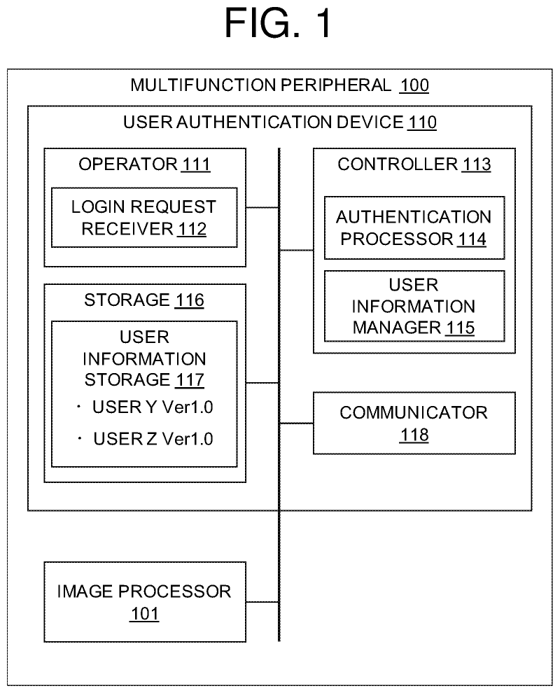

First, configurations of a user authentication device and an image processing apparatus are described. FIG. 1 is a block diagram illustrating the configurations of the user authentication device and the image processing apparatus according to the present embodiment. FIG. 1 illustrates a multifunction peripheral that is an example of the image processing apparatus. The multifunction peripheral 100 includes an image processor 101 that executes image processing and the user authentication device 110 that performs user authentication.

The image processor 101 has a known configuration to read the image on a document and a known configuration to execute printing.

The user authentication device 110 includes components regarding a user authentication process in the multifunction peripheral 100. Specifically, the user authentication device 110 includes an operator 111, a controller 113, a storage 116, and a communicator 118.

The operator 111 includes a login request receiver 112. The controller 113 includes an authentication processor 114 and a user information manager 115. The storage 116 includes a user information storage 117.

All or a part of the above-described components may be common hardware resources shared by the image processor 101.

The operator 111 receives the user's operation on the user authentication device 110. The specific mode thereof is, for example, an operator including an operation key or a touch panel to receive the user's operation. The operator 111 may receive the user's operation on the multifunction peripheral 100 as well as the operation on the user authentication device 110.

The login request receiver 112 receives a request regarding a user login.

The controller 113 uses, for example, a control circuitry, primarily a CPU and a memory, as hardware resources so that the CPU executes a control program previously stored in the memory to perform a function of the controller. That is, the hardware resources and the software resources are organically bonded to perform the function.

The authentication processor 114, which is a part of the functions of the controller 113, performs user authentication in accordance with a login request received by the login request receiver 112.

The user information manager 115, which is a part of the functions of the controller 113, performs the process to store the user information in the user information storage 117 and share the user information stored in each image processing apparatus with an external image processing apparatus connected via a network.

In this description, the user information includes the authentication information used for user authentication, and the user information further includes, for example, user-specific settings and data. The authentication information includes a username and a password. The user-specific settings may be, for example, user-specific settings regarding an operation or may be data regarding a user-specific application.

The controller 113 may further include the function to control a mechanism and a circuitry of the image processor 101. The present invention is not limited thereto, and a hardware resource of the image processor 101 different from the controller 113 may perform the function.

The storage 116 stores data and settings needed by the controller 113 to execute processing. Examples of the specific mode thereof include a ROM, a RAM, a flash memory, a hard disk drive, or a combination thereof. The hardware resources of the storage 116 may be common to those of the memory storing the data regarding the control and the image processing of the image processor 101.

The user information storage 117 is a non-volatile memory that stores user-specific information (user information).

The communicator 118 is an interface circuitry to communicate with an external device connected via a network.

Formation of Group of Multifunction Peripherals

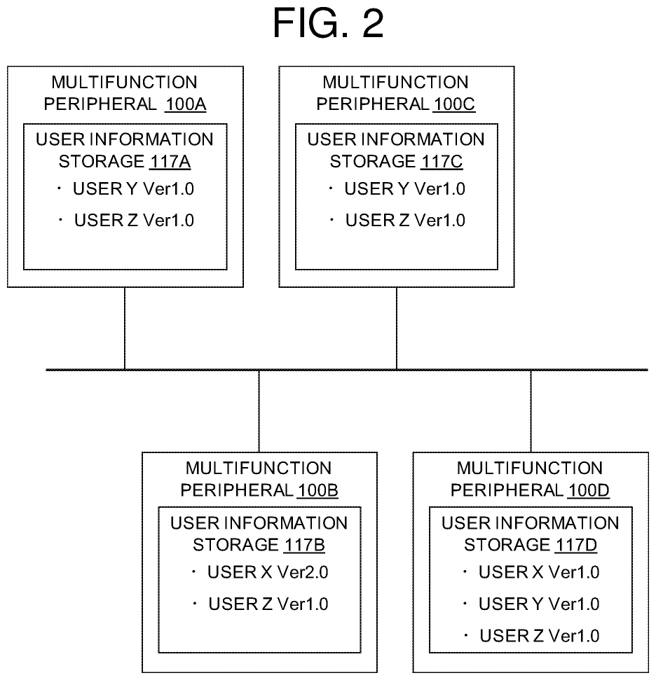

FIG. 2 is an explanatory diagram illustrating a mode in which a plurality of multifunction peripherals each storing authentication information is connected via a network according to the present embodiment. As illustrated in FIG. 2, four multifunction peripherals 100A, 100B, 100C, and 100D are connected via the network. It is assumed that each of the multifunction peripherals 100A, 100B, 100C, and 100D has the configuration of the multifunction peripheral 100 illustrated in FIG. 1.

The multifunction peripherals 100A, 100B, 100C, and 100D may transmit and receive information to and from each other. That is, all the multifunction peripherals belong to the same group.

The group to which each multifunction peripheral belongs is set by the user using the operator 111 of each multifunction peripheral. The controller 113 stores the setting in the storage 116 of each multifunction peripheral. In this mode, all the multifunction peripherals connected via the same network do not always belong to the same group and may include a mode in which only a part of the multifunction peripherals belongs to the same group.

In another mode, a broadcast (transmission to unspecified multifunction peripherals on the network) is executed on all the multifunction peripherals connected via the same network via the communicator of any of the multifunction peripherals connected via the network. The multifunction peripheral that transmits a broadcast and the multifunction peripheral that replies to the broadcast in a predetermined format transmit and receive the information needed for group formation so as to form one group.

Each multifunction peripheral may previously have the setting as to whether to reply when a broadcast is received and may store the setting in the storage 116.

A broadcast is transmitted when the user performs a specific operation using the operator 111 of any of the multifunction peripherals connected via the network. The specific operation may be a predetermined operation regarding the formation or update of a group. Alternatively, the specific operation may be an operation regarding the request for a user login. In that case, each time a user login operation is performed on any of the multifunction peripherals, the process related to group formation is performed to update the group.

Storage of User Information

In FIG. 2, a user information storage 117A of the multifunction peripheral 100A stores the user information of version 1.0 regarding a user Y and a user Z.

The user information manager 115 manages the storage and the update of the version information regarding the user information on a user-by-user basis.

For example, the version information is updated when the password is changed. The user information manager 115 updates the version information also when any element included in the user information is updated, such as authentication information other than a password, operation-related settings, or data regarding a user-specific application. According to the present embodiment, the user information manager 115 assigns the version information having a larger value to the user information on a certain user as the user information on the user is updated. For example, between Ver 1.0 and Ver 2.0, Ver 2.0 is newer than Ver 1.0.

A user information storage 117B of the multifunction peripheral 100B stores the user information of version 2.0 regarding a user X and the user information of version 1.0 regarding the user Z.

A user information storage 117C of the multifunction peripheral 100C stores the user information of version 1.0 regarding the user Y and the user information of version 1.0 regarding the user Z.

A user information storage 117D of the multifunction peripheral 100D stores the user information regarding the user X, the user Y, and the user Z, for all of which the versions are 1.0.

With regard to the user information on the user X, the multifunction peripheral 100B stores the user information of version 2.0, and the multifunction peripheral 100D stores the user information of version 1.0. The multifunction peripherals 100A and 100C do not store the user information on the user X.

Such a state occurs, for example, as described below. It is assumed that only the multifunction peripherals 100B and 100D previously store the user information of version 1.0 regarding the user X prior to the state illustrated in FIG. 2, and then the password of the user X is changed in the multifunction peripheral 100B. In accordance with a change in the password, the version of the user information on the user X in the multifunction peripheral 100B is updated to 2.0.

When the multifunction peripheral 100B does not have the setting to transmit a user information update request to the other multifunction peripherals in response to the update to the user information, however, the user information on the user X is updated in the multifunction peripherals 100A, 100C, and 100D, which results in the state illustrated in FIG. 2.

Alternatively, although the multifunction peripheral 100B transmits a user information update request to the other multifunction peripherals in response to the update to the user information, none of the other multifunction peripherals is able to receive the notification, which results in the state illustrated in FIG. 2. The state where a notification is not receivable is, for example, the state where the power of the multifunction peripheral is completely off.

Process Regarding Login

Here, a case where the operator 111 of the multifunction peripheral 100A illustrated in FIG. 2 receives, as the login request receiver 112, a login operation by the user X is described. The above-described login operation includes the input of the username and the password of the user X.

The controller 113 of the multifunction peripheral 100A checks, as the authentication processor 114, whether the storage 116 of the multifunction peripheral 100A stores the user information on the user X in response to the received login request. When the corresponding user information is stored, the authentication information included in the user information is acquired as one of the candidates used for user authentication.

In the example illustrated in FIG. 2, however, the user information storage 117A of the multifunction peripheral 100A does not store the user information on the user X.

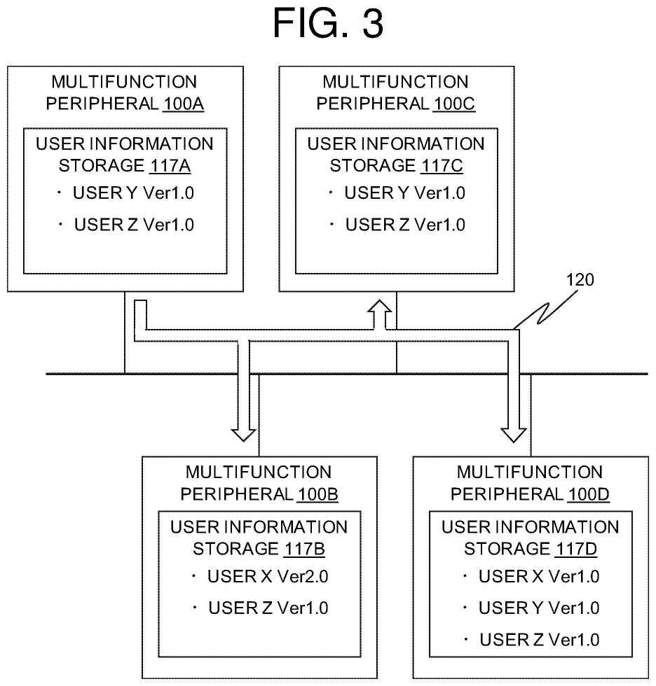

Then, the controller 113 of the multifunction peripheral 100A requests, as the authentication processor 114, an external multifunction peripheral to provide the user information on the user X. Specifically, as illustrated in FIG. 3, a user information provision request 120 is transmitted to the multifunction peripherals 100B, 100C, and 100D via the communicator 118. The user information provision request 120 includes the username of the user X regarding the login request.

The multifunction peripherals 100B, 100C, and 100D belong to the same group as that of the multifunction peripheral 100A. The group is formed as described above.

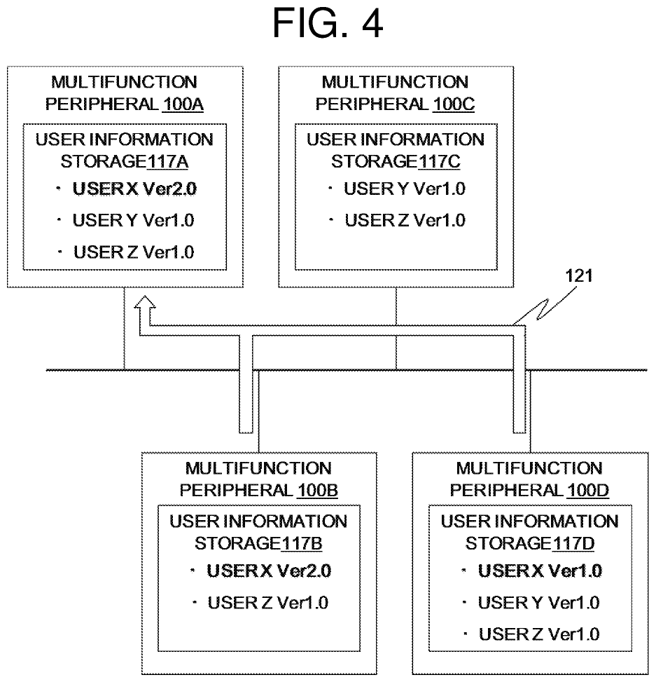

After receiving the user information provision request 120 from the multifunction peripheral 100A, each of the multifunction peripherals 100B, 100C, and 100D checks whether the storage 116 of its own stores the user information on the user X. When the corresponding user information is stored, the user information is transmitted to the multifunction peripheral 100A (see FIG. 4).

As illustrated in FIGS. 2 and 3, the user information storage 117B of the multifunction peripheral 100B and the user information storage 117D of the multifunction peripheral 100D store the user information on the user X. However, the user information storage 117C of the multifunction peripheral 100C does not store the user information on the user X.

Therefore, as illustrated in FIG. 4, the multifunction peripherals 100B and 100D transmit user information 121 on the user X to the multifunction peripheral 100A having requested the user information. The multifunction peripheral 100C transmits no user information to the multifunction peripheral 100A.

After receiving the user information 121 on the user X from the multifunction peripherals 100B and 100D, the controller 113 of the multifunction peripheral 100A determines, as the authentication processor 114, whether either one of the two sets of user information 121 on the user X received from the multifunction peripherals 100B and 100D is to be used for user authentication.

In the example illustrated in FIG. 4, the authentication processor 114 of the multifunction peripheral 100A determines that the newer version 2.0 is to be used for user authentication based on the version information added to the user information 121.

Then, the user information 121 on the user X that is determined to be used for user authentication is newly stored in the user information storage 117A of the multifunction peripheral 100A. The user information 121 on the user X is stored in the user information storage 117A regardless of whether the user authentication of the user X succeeds or fails afterward.

The authentication processor 114 of the multifunction peripheral 100A performs user authentication using the authentication information of version 2.0 regarding the user X. Specifically, the password of the user X received by the operator 111 of the multifunction peripheral 100A, which functions as the login request receiver 112, is checked against the password in the user information of version 2.0 regarding the user X, acquired from the multifunction peripheral 100B and stored in the user information storage 117A of the multifunction peripheral 100A, so that it is determined whether the two match.

It is determined that the user authentication is successful when the passwords match, and the authentication processor 114 of the multifunction peripheral 100A permits the login of the user X. Conversely, it is determined that the user authentication is not successful when the passwords do not match, and the authentication processor 114 of the multifunction peripheral 100A does not permit the login of the user X. The authentication processor 114 causes the operator 111 to indicate that the password is mismatched so as to notify the user of a mismatch.

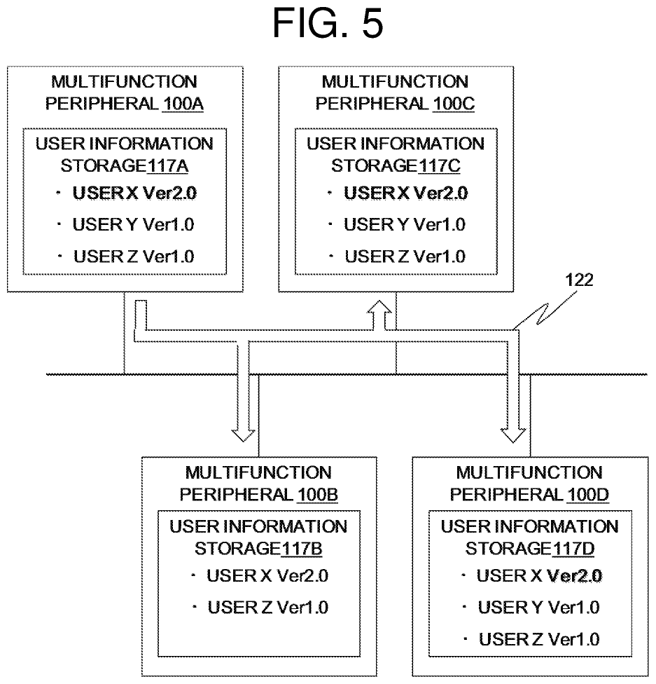

When the user authentication is successful, the controller 113 of the multifunction peripheral 100A transmits, as the user information manager 115, a user information update request 122 to the multifunction peripherals 100B, 100C, and 100D (see FIG. 5). The user information on the user X used for the successful user authentication is added to the user information update request 122.

After receiving the user information update request 122, the user information manager 115 of each of the multifunction peripherals 100B, 100C, and 100D newly stores the user information on the user X in the storage 116 of the corresponding multifunction peripheral when the user information on the user X is not stored. When the already stored user information has the old version, the user information is updated to the received user information.

As described above, with regard to the user information on the user X who has requested a login from the multifunction peripheral 100A, the processing for storage and update is performed on the multifunction peripherals 100B, 100C, and 100D belonging to the same group in response to the success of the login.

The above is an example of the process performed by the controller 113 as the authentication processor 114 in response to a login request.

Flowchart

The flow of the above process is described with reference to flowcharts.

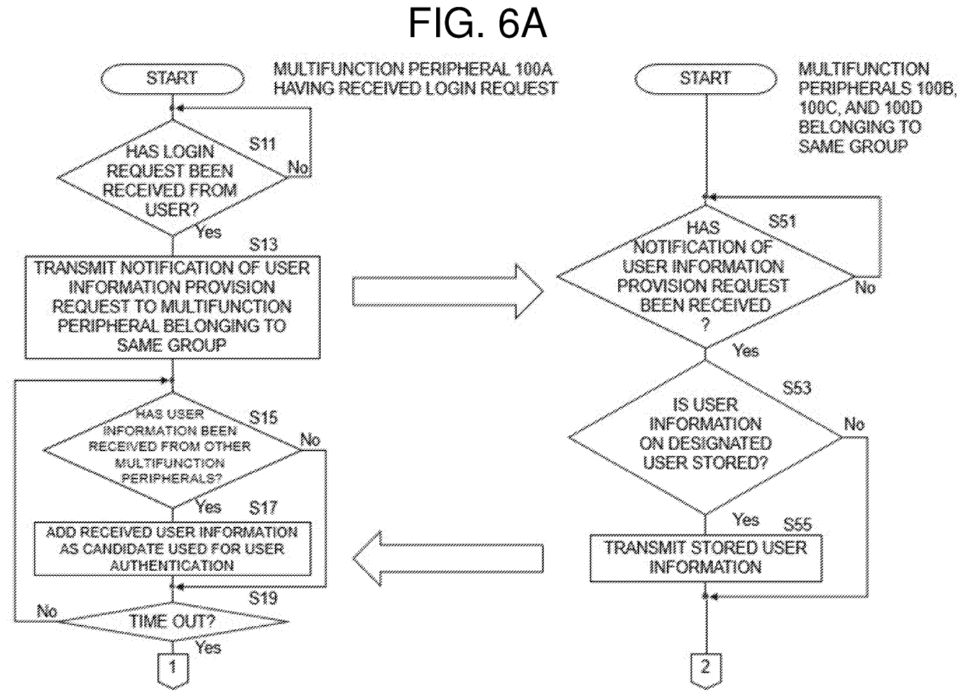

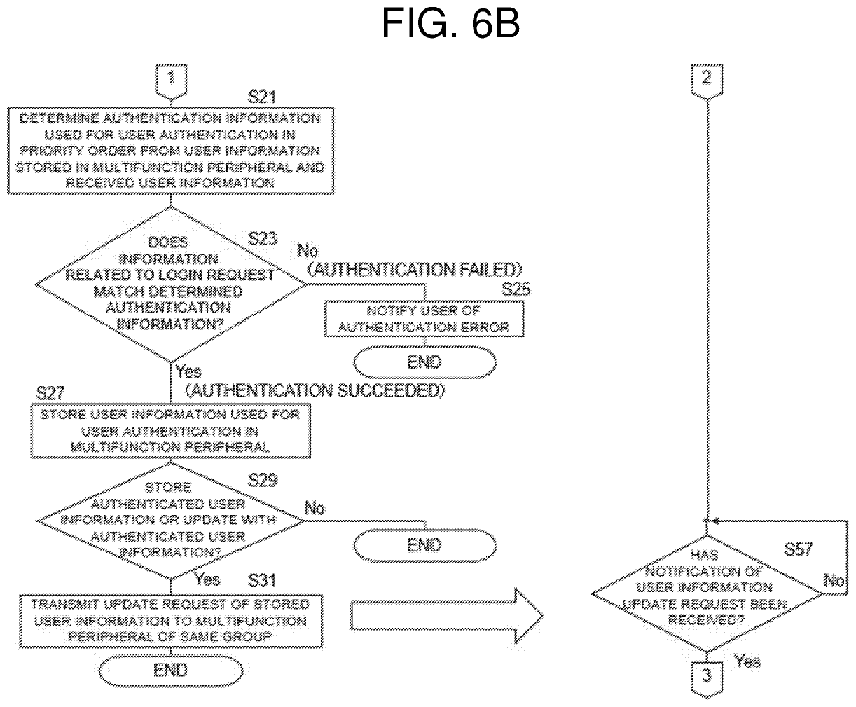

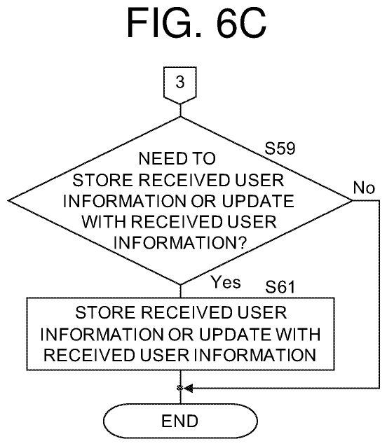

FIGS. 6A to 6C are flowcharts illustrating an example of the process in which the authentication processor performs user authentication according to the present embodiment. In the drawings, the flowchart on the left side illustrates the process performed by the controller 113 of the multifunction peripheral 100A having received a login request, and the flowchart on the right side illustrates the process performed by the controller 113 of each of the other multifunction peripherals (the multifunction peripherals 100B, 100C, and 100D) belonging to the same group as that of the multifunction peripheral 100A.

As illustrated in FIG. 6A, the controller 113 of the multifunction peripheral 100A, which receives a login request, monitors, as the authentication processor 114, whether a login request has been received from the user (Step S11).

When the controller 113 of the multifunction peripheral 100A has received a login request (Yes at Step S11), the controller 113 of the multifunction peripheral 100A checks, as the authentication processor 114, whether the user information on the user X is stored in the storage 116 of the multifunction peripheral 100A in response to the received login request. Further, a notification of a user information provision request is transmitted to the multifunction peripherals 100B, 100C, and 100D belonging to the same group (Step S13).

The controller 113 of the multifunction peripheral, which receives the user information provision request from the multifunction peripheral 100A, performs the process below in response to reception of the notification of the user information provision request (Yes at Step S51). Specifically, it is checked whether the user information storage 117 in the storage 116 of the corresponding multifunction peripheral stores the user information regarding the username added to the user information provision request (Step S53).

When the corresponding user information is stored (Yes at Step S53), the stored user information is returned (Step S55).

Conversely, when the corresponding user information is not stored (No at Step S53), nothing is returned.

The authentication processor 114 of the multifunction peripheral 100A, which has transmitted the user information provision request, waits for the user information returned from the other multifunction peripherals (Step S15).

When the user information has been received from any of the other multifunction peripherals (Yes at Step S15), the authentication processor 114 adds the received user information as the candidate used for user authentication (Step S17).

The controller 113 of the multifunction peripheral 100A waits, as the authentication processor 114, for the user information returned from the other multifunction peripherals until a predetermined period elapses (the loop to Step S15 after No at Step S19). The user may change the setting in each of the multifunction peripherals during the waiting period for the returned user information. Thus, it is possible to set the preferable period corresponding to the loads on the network and the number of multifunction peripherals belonging to the same group.

After the predetermined period has elapsed (Yes at Step S19), the authentication processor 114 of the multifunction peripheral 100A performs the process below. Specifically, the authentication information to be used for user authentication is determined in accordance with a predetermined priority order from, as the candidate targets, the user information on the designated user, i.e., the user information stored in the user information storage 117A and the user information received from the other multifunction peripherals (Step S21 in FIG. 6B).

In the above example, to determine the authentication information to be used, priority is given to the user information of the new version regarding the designated user.

The authentication processor 114 of the multifunction peripheral 100A performs user authentication using the determined authentication information. Specifically, the password of the user X received by the operator 111 of the multifunction peripheral 100A, as the login request receiver 112, is checked against the version 2.0 password of the user X to determine whether the two match (Step S23).

When the passwords do not match (No at Step S23), the authentication processor 114 determines that the user authentication is unsuccessful and does not permit a login of the user X. The operator 111 indicates that the user authentication is unsuccessful to notify the user of an unsuccessful user authentication (Step S25) and ends the process for a login.

Conversely, when the passwords match (Yes at Step S23), the authentication processor 114 determines that the user authentication is successful and permits a login of the user X.

When the user authentication is successful, the controller 113 of the multifunction peripheral 100A stores, as the user information manager 115, the user information used for the user authentication, in the user information storage 117A (Step S27).

Subsequently, the user information manager 115 checks whether the other multifunction peripherals belonging to the same group have been previously set to store the user information on the user X or update with the user information on the user X (Step S29).

When the other multifunction peripherals are not set to store the user information or update with the user information (No at Step S29), the process for a login ends.

Conversely, when the other multifunction peripherals have been set to store the user information or update with the user information (Yes at Step S29), the user information manager 115 transmits a user information update request to the multifunction peripherals 100B, 100C, and 100D belonging to the same group (Step S31) and ends the process.

The controller 113 of the multifunction peripheral, which receives the user information update request from the multifunction peripheral 100A, performs, as the user information manager 115, the process below in response to receiving the notification of the user information update request (Yes at Step S57). Specifically, when the user information on the user X added to the user information update request is not stored in the user information storage 117 in the storage 116 of the corresponding multifunction peripheral, the user information is stored. When the old user information is stored, the old user information is updated (S61 after Yes at Step S59 in FIG. 6C).

When the latest user information is already stored (No at Step S59), the process ends without performing anything.

The above is the flow of the process for a login.

### Second Embodiment

According to the first embodiment, as illustrated in FIG. 4, after receiving the user information provision request 120, each of the multifunction peripherals returns the user information only on the user (the user X) regarding a login request to the transmission source.

According to a different mode, each multifunction peripheral may transmit all the pieces of user information stored in the corresponding multifunction peripheral. Furthermore, the user information manager 115 of the multifunction peripheral, which has received the pieces of user information, may transmit the notification of the user information update request with the user information on all the users added thereto. As described above, the process may be performed for the storage and the update of the user information stored in the user information storage of each multifunction peripheral with regard to all the registered users.

According to this mode, when any user performs a login operation on any of the multifunction peripherals, all the pieces of user information stored in the multifunction peripherals belonging to the same group are exchanged so as to perform the process for the storage and update of the user information.

Compared with the first embodiment, the processing load and the communication load for the storage and the update of user information are higher. However, the process for the storage and update of the user information in each multifunction peripheral is performed more quickly.

Furthermore, an arrangement is possible in which whether each multifunction peripheral returns the user information after receiving the user information provision request 120 may be set in the multifunction peripheral.

### Third Embodiment

According to the first embodiment, to determine the authentication information to be used, priority is given to the user information of the new version regarding the designated user.

According to an example of a different mode for determining the authentication information to be used for user authentication in accordance with the priority order, when the user information on the user who has requested a login is stored in the user information storage 117 of the corresponding multifunction peripheral, the user information stored in the corresponding multifunction peripheral is given priority over the user information acquired from an external multifunction peripheral and is used for user authentication.

Further, the priority order of the multifunction peripherals may be previously set. The authentication processor 114 uses, for user authentication, the user information acquired from the multifunction peripheral having the highest priority order among the user information acquired from the multifunction peripherals including the multifunction peripheral of its own. The priority order of the multifunction peripherals may be set collectively for each group or may be set individually for each multifunction peripheral.

### Fourth Embodiment

According to the first embodiment, as illustrated in FIG. 5, the user information update request 122 is transmitted to all the multifunction peripherals belonging to the same group.

According to a different mode, it is possible to set to which of the multifunction peripherals belonging to the same group the user information update request 122 is to be transmitted.

Alternatively, the user information update request 122 may be transmitted to only the multifunction peripheral that has returned the user information.

An arrangement is also possible in which whether to store the user information in the user information storage 117 of the multifunction peripheral of its own or update with the user information can be set.

These settings may be set collectively for each group or may be set individually for each multifunction peripheral.

As described above, (i) a user authentication device according to the present invention includes: a login request receiver that receives a request for a login from a user; an authentication processor that performs user authentication in response to the request; a user information storage that previously stores authentication information used by the authentication processor for user authentication; and a communicator that transmits and receives information to and from external image processing apparatuses connected via a network, wherein the authentication processor, in response to the received request, transmits a notification to at least any of the connected external image processing apparatuses via the communicator so as to provide authentication information on the user, and permits a login of the user when the user has been authenticated based on either authentication information stored in the user information storage or authentication information provided by the external image processing apparatus in response to the notification.

According to the present invention, the login request receiver receives the request for a login of the user. The specific mode thereof is, for example, an operator including an operation key or a touch panel that receives the user's operation.

A login is the procedure to acquire the authority to use when the image processing apparatus is used. The user acquires the authority to use when the authentication processor described below authenticates the user in response to the login request. The user does not acquire the authority to use when the user is not authenticated. In some modes, however, even though the user is not given the authority as the unique user, the user is given the authority as a guest user or a general user (the authority given to anyone) so as to be permitted a use within a limited range.

The authentication processor authenticates the user based on the request received by the login request receiver. The specific mode thereof is, for example, a control circuitry, primarily a CPU and a memory. The CPU executes a control program previously stored in the memory so that the hardware resources and the software resources are organically bonded to perform the function of the authentication processor.

The user information storage is a non-volatile memory that stores user-specific information (user information). The specific mode thereof is, for example, a flash memory or a hard disk drive. The user information includes the authentication information used for user authentication. The user information may include, for example, user-specific settings and data in addition to user-specific authentication information. The specific settings may be, for example, operation-related settings or data for a user-specific application.

The communicator is an interface circuitry to communicate with an external image processing apparatus. Any communication method and mode may be used.

(ii) A different mode of the present invention includes an image processing apparatus including the above-described user authentication device.

Preferred modes of the present invention are further described.

(iii) The notification may include an attribute of a group, the external image processing apparatus connected via the network may previously have a setting as to whether the external image processing apparatus belongs to the group, and the external image processing apparatus belonging to the same group may exclusively provide the authentication information.

Thus, the authentication information is shared by some of the closely related image processing apparatuses, as the same group, among the image processing apparatuses connected via the network, that is, the authentication information is not shared by other image processing apparatuses that are less related.

(iv) The external image processing apparatus connected via the network may previously have a setting as to whether the external image processing apparatus responds to the notification, and the external image processing apparatus having a setting to respond to the notification may exclusively provide the authentication information.

Thus, the image processing apparatus may previously have the setting as to whether to share the authentication information with any of the image processing apparatuses connected via the network.

(v) A user information manager may be further provided to store newly generated authentication information or updated authentication information in the user information storage, wherein the user information manager may add, to the authentication information, version information indicating a chronological order of generation and update of the authentication information on a same user, and the authentication processor may perform the user authentication by using authentication information having a latest version added thereto among authentication information stored in the user information storage or authentication information provided by the external image processing apparatus.

Thus, when multiple pieces of authentication information on the same user are acquired from the user information storage and any of the external image processing apparatuses, the authentication information with the latest version is determined based on the added version information so that user authentication may be performed using the determined authentication information.

(vi) When authentication information stored in the user information storage or authentication information provided by the external image processing apparatus includes a different version, the user information manager may update authentication information having an old version stored in the user information storage or the external image processing apparatus.

Thus, the authentication information having an old version may be updated to the authentication information having a new version when the authentication information having a different version is acquired from the user information storage and any of the external image processing apparatus.

(vii) The authentication processor may use firstly provided authentication information when performing the user authentication using any of a plurality of pieces of authentication information provided by the external image processing apparatuses.

Thus, the authentication processor may perform the user authentication in the shortest time by using the firstly provided authentication information.

(viii) A different mode of the present invention includes a user authentication method implemented by a computer, the user authentication method including: receiving a request for a login from a user; in response to the received request, transmitting a notification to at least any of external image processing apparatuses connected via a network so as to provide authentication information on the user, and permitting a login of the user when the user has been authenticated based on either authentication information previously stored in a user information storage or authentication information provided by the external image processing apparatus in response to the notification.

A preferred mode of the present invention also includes the combination of any of the above-described modes.

In addition to the above-described embodiments, there may be various modifications of the present invention. It should not be understood that the modifications do not belong to the scope of the present invention. The present invention should include the scope of claims, equivalent meanings, and all modifications within the scope.

What is claimed is:

1. A user authentication device comprising:
a login request receiver that receives a request for a login from a user;
an authentication processor that performs user authentication in response to the request;
a user information storage that previously stores authentication information used by the authentication processor for user authentication; and
a communicator that transmits and receives information to and from external image processing apparatuses connected via a network, wherein
the authentication processor
in response to the received request, transmits a notification to at least any of the connected external image processing apparatuses via the communicator so as to provide authentication information on the user, and
permits a login of the user when the user has been authenticated based on either authentication information stored in the user information storage or authentication information provided by the external image processing apparatus in response to the notification.

2. An image processing apparatus including the user authentication device according to claim 1.

3. The image processing apparatus according to claim 2, wherein
the notification includes an attribute of a group,
the external image processing apparatus connected via the network previously has a setting as to whether the external image processing apparatus belongs to the group, and
the external image processing apparatus belonging to the same group exclusively provides the authentication information.

4. The image processing apparatus according to claim 2, wherein
the external image processing apparatus connected via the network previously has a setting as to whether the external image processing apparatus responds to the notification, and
the external image processing apparatus having a setting to respond to the notification exclusively provides the authentication information.

5. The image processing apparatus according to claim 2, further comprising a user information manager that stores newly generated authentication information or updated authentication information in the user information storage, wherein
the user information manager adds, to the authentication information, version information indicating a chronological order of generation and update of the authentication information on a same user, and
the authentication processor performs the user authentication by using authentication information having a latest version added thereto among authentication information stored in the user information storage or authentication information provided by the external image processing apparatus.

6. The image processing apparatus according to claim 5, wherein
when authentication information stored in the user information storage or authentication information provided by the external image processing apparatus has a different version, the user information manager updates authentication information having an old version stored in the user information storage or the external image processing apparatus.

7. The image processing apparatus according to claim 2, wherein
the authentication processor uses firstly provided authentication information when performing the user authentication using any of a plurality of pieces of authentication information provided by the external image processing apparatuses.

8. A user authentication method implemented by a computer, the user authentication method comprising:
receiving a request for a login from a user;
in response to the received request, transmitting a notification to at least any of external image processing apparatuses connected via a network so as to provide authentication information on the user, and
permitting a login of the user when the user has been authenticated based on either authentication information previously stored in a user information storage or authentication information provided by the external image processing apparatus in response to the notification.
